(19) United States
(12) Patent Application Publication
(10) Pub. No.: US 2025/0004300 A1
(43) Pub. Date: Jan. 2, 2025

(54) A METHOD FOR DETERMINING AN OPHTHALMIC LENS ADAPTED TO SLOW DOWN THE PROGRESSION OF A VISION IMPAIRMENT AND A CORRESPONDING OPHTHALMIC LENS

(71) Applicant: Essilor International, Charenton-Le-Pont (FR)

(72) Inventors: Samy HAMLAOUI, Paris (FR); Guillaume GIRAUDET, Orleans (FR); David RIO, Gometz-Le-Chatel (FR); Matthieu GUILLOT, Issy Les Moulineaux (FR)

(73) Assignee: Essilor International, Charenton-Le-Pont (FR)

(21) Appl. No.: 18/709,128

(22) PCT Filed: Aug. 30, 2022
(86) PCT No.: PCT/EP2022/073997

§ 371 Date: May 10, 2024

(30) Foreign Application Priority Data
Nov. 18, 2021 (EP) 21306610.3

(51) Int. Cl. G02C 7/02

(52) U.S. Cl. CPC G02C 7/027; G02C 7/022; G02C 7/028; G02C 2202/24

(57) ABSTRACT

A method for determining an ophthalmic lens adapted to slow down progression of a vision impairment of an eye of a wearer, the lens having a front surface and a back surface and at least one optical area not focusing an image on the retina of the eye. The method includes providing a plurality of wearer parameters, including at least a prescription and an indication about the need for slowing down the progression of the vision impairment, selecting a semi-finished lens that best corresponds to at least the prescription, defining at least one optical target for the front and/or back surface, taking account of the plurality of wearer parameters, and minimizing a cost function relating to the at least one optical target, so as to determine an optimized front and/or back surface of the semi-finished lens as the front and/or back surface of the ophthalmic lens.

### FIELD OF THE DISCLOSURE

The present disclosure relates to a method for determining an ophthalmic lens adapted to slow down the progression of a vision impairment. The present disclosure also relates to a corresponding ophthalmic lens.

### BACKGROUND OF THE DISCLOSURE

Vision impairment is in some cases defined by the fact that the eye does not focus objects on the retina. For example, in the case of myopia, the eye focuses distant objects in front of its retina. Myopia is usually corrected using a concave lens. Hyperopia is usually corrected using a convex lens.

For simplification, by way of non-limiting example, in the following, only the example of myopia will be considered. However, the present disclosure applies to other kinds of vision impairment as well.

Rather than merely correcting myopia, it is currently possible to slow down myopia, by providing ophthalmic lenses comprising predefined microstructures such as microlenses.

For instance, document WO-A-2019/166657 discloses a lens having such microlenses that compensate for some oblique astigmatism, so that for a 30° off axis angle, microlenses provide point focusing.

However, no means is provided for modifying or adjusting the lens characteristics based on the wearer's needs or individual parameters such as the prescription, fitting parameters, myopia control strength, etc.

Therefore, there is a need for improving myopia control for each individual wearer.

### SUMMARY OF THE DISCLOSURE

An object of the disclosure is to overcome the above-mentioned drawbacks of the prior art.

To that end, the disclosure provides a method for determining an ophthalmic lens adapted to slow down the progression of a vision impairment of an eye of a wearer according to claim 1.

Thus, the proposed method takes into account the prescription of the considered wearer as well as the need for slowing down the progression of the wearer's vision impairment for determining an optimized front and/or back surface of an ophthalmic lens that will improve the slowing down of the progression of that vision impairment, starting from an available collection of semi-finished lenses.

To the same end as mentioned above, the present disclosure further provides a computer program product according to claim 11.

To the same end as mentioned above, the present disclosure further provides a non-transitory information storage medium according to claim 12.

As the advantages of the computer program product and of the computer-readable storage medium are similar to those of the method, they are not repeated here.

The computer program product and the computer-readable storage medium are advantageously configured for executing the method in any of its execution modes.

### BRIEF DESCRIPTION OF THE DRAWINGS

For a more complete understanding of the description provided herein and the advantages thereof, reference is now made to the brief descriptions below, taken in connection with the accompanying drawings and detailed description, wherein like reference numerals represent like parts.

FIG. 1 is a flow diagram showing steps of a method according to the present disclosure, in a particular embodiment.

FIG. 2 shows a semi-finished lens having a non-limiting example of patterns of optical areas according to the present disclosure, in a particular embodiment.

FIG. 3 is a schematic view illustrating an optical configuration used in calculations in a particular embodiment of the method according to the present disclosure.

FIG. 4 is a flow diagram showing steps of a method according to the present disclosure, in another particular embodiment.

FIG. 5 is a graph showing a non-limiting example of a pattern of optical areas according to the present disclosure, in a particular embodiment.

FIG. 6 is a graph showing a non-limiting example of an optical target according to the present disclosure, in the embodiment of FIG. 5.

FIG. 7 is a graph showing a non-limiting example of the distribution of the mean surfacic power of the front surface of a semi-finished lens according to the present disclosure, in the embodiment of FIG. 5.

FIG. 8 is a graph showing a non-limiting example of the distribution of the mean surfacic power of the optimized back surface of the semi-finished lens of FIG. 7.

### DETAILED DESCRIPTION OF THE DISCLOSURE

In the description which follows, although making and using various embodiments are discussed in detail below, it should be appreciated that as described herein are provided many inventive concepts that may embodied in a wide variety of contexts. Embodiments discussed herein are merely representative and do not limit the scope of the disclosure. It will also be obvious to one skilled in the art that all the technical features that are defined relative to a process can be transposed, individually or in combination, to a device and conversely, all the technical features relative to a device can be transposed, individually or in combination, to a process and the technical features of the different embodiments may be exchanged or combined with the features of other embodiments.

The terms “comprise” (and any grammatical variation thereof, such as “comprises” and “comprising”), “have” (and any grammatical variation thereof, such as “has” and “having”), “contain” (and any grammatical variation thereof, such as “contains” and “containing”), and “include” (and any grammatical variation thereof such as “includes” and “including”) are open-ended linking verbs. They are used to specify the presence of stated features, integers, steps or components or groups thereof, but do not preclude the presence or addition of one or more other features, integers, steps or components or groups thereof. As a result, a method, or a step in a method, that “comprises”, “has”, “contains”, or “includes” one or more steps or elements possesses those one or more steps or elements, but is not limited to possessing only those one or more steps or elements.

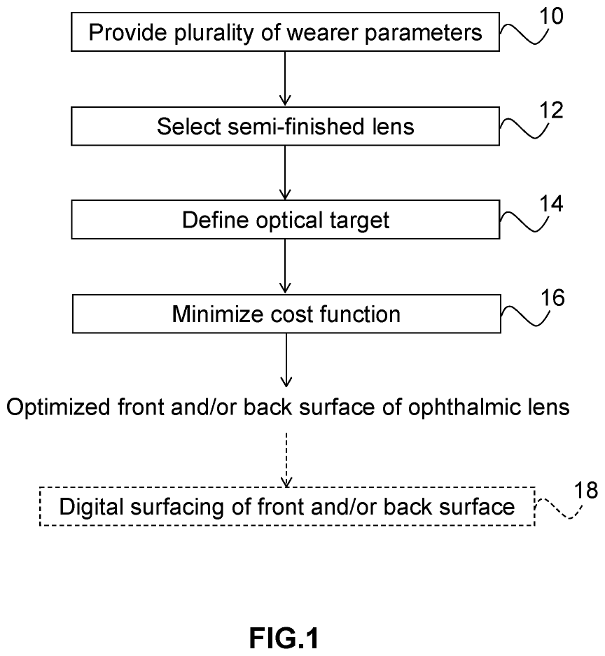

The flow diagram of FIG. 1 shows steps of a method according to the present disclosure in a particular embodiment. The method is for determining an ophthalmic lens adapted to slow down the progression of a vision impairment of an eye of a wearer.

By way of non-limiting example, the vision impairment may be myopia. However, as indicated above, the present disclosure applies to other kinds of vision impairment as well.

The ophthalmic lens has a front surface and a back surface. Furthermore, on the front surface, or on the back surface, or on both the front and back surfaces, or between the front and back surfaces, the ophthalmic lens has one or more optical areas not focusing an image on the retina of the eye.

By way of non-limiting example, the optical areas may comprise one or more micro-structures, such as microlenses. The optical areas may have various shapes, such as rings, or circles, or hexagonal shapes, or elliptical shapes, or free form surfaces, or NURBS (Non-Uniform Rational B-spline Surfaces). This list of examples is not limiting.

As shown in FIG. 1, during a first step 10 of the method, a plurality of wearer parameters are provided. Such wearer parameters comprise at least a prescription and an indication about the need for slowing down the progression of the vision impairment of the eye of the wearer.

As additional wearer parameters, if the considered vision impairment is myopia, the myopia progression rate may also be provided.

Fitting parameters may also be provided as additional wearer parameters.

Based on at least the prescription and optionally based on additional wearer parameters, during a next step 12, a semi-finished lens that best corresponds to at least the prescription and that optionally also best corresponds to the additional wearer parameters is selected among a plurality of semi-finished lenses.

If the considered vision impairment is myopia, in a first non-limiting example where there are optical areas only on the front surface of the semi-finished lens, the specification of the optical areas is dependent on the sphere prescription. For higher myopia, there will be more optical areas on the front surface and the optical areas will have more power/asphericity. Table 1 below gives corresponding examples of values of the sphere (in diopters), the front base curve (in diopters), the density of optical areas (in %), the mean power addition of the optical area (in diopters) and the power variation of the optical area (in diopters), which measures the asphericity of an optical area.

TABLE 1

| | | | Optical area | Optical area |
|---|---|---|---|---|
| | Front base | Optical area | mean power | power |
| Sphere (D) | curve (D) | density (%) | addition (D) | variation (D) |
| 0 | 6 | 20 | 2 | 1 |
| −2 | 4 | 30 | 3 | 1.5 |
| −4 | 3 | 40 | 4 | 2 |
| −6 | 2 | 60 | 5 | 2.5 |

In this first example, since most of the characteristics of the optical areas are built on the front surface of the semi-finished lens, the calculated back surface should not deviate a lot from an aspheric/atoric surface, in order to minimize the wearer power and resulting astigmatism.

If the considered vision impairment is myopia, in a second non-limiting example where there are optical areas only on the front surface of the semi-finished lens, example values of minimal characteristics of the optical areas that are constant with respect to the sphere prescription are given in Table 2 below.

TABLE 2

| | | | Optical area | Optical area |
|---|---|---|---|---|
| | Front base | Optical area | mean power | power |
| Sphere (D) | curve (D) | density (%) | addition (D) | variation (D) |
| 0 | 6 | 20 | 2 | 0 |
| −2 | 4 | 20 | 2 | 0 |
| −4 | 3 | 20 | 2 | 0 |
| −6 | 2 | 20 | 2 | 0 |

In this second example, a significant modification work may have to be carried out on the semi-finished lens in order to obtain a satisfying final ophthalmic lens. This may be advantageous when using a prediction of myopia evolution for a specific wearer. Indeed, a model could take as inputs a number of eye characteristics of the wearer (axial length, aberrations, peripheral refraction, etc.), as well as other possible factors (age, history of high myopia in the family, etc.) and return a predicted rate of myopia evolution. Low, respectively high, predicted myopia rates will require lower, respectively higher, densities of optical areas i.e. myopia control areas and these areas will be of lower, respectively higher, power/asphericity.

If the considered vision impairment is myopia, in a third non-limiting example where there are optical areas only on the front surface of the semi-finished lens, another possible set of semi-finished lenses is a set of different base curves combined with different strengths (power or density) of optical areas based on a predicted rate of myopia evolution for the wearer, so as to take account of the fact that for similar prescriptions, different wearers may have different predicted rates of myopia evolution. Table 3 below gives examples of values of the sphere (in diopters), the front base curve (in diopters), the strength of the optical area, the density of optical areas (in %), the mean power addition of the optical area (in diopters) and the power variation of the optical area (in diopters).

TABLE 3

| | | | | Optical | |
|---|---|---|---|---|---|
| | | | Optical | area mean | Optical |
| | | Optical | area | power | area power |
| | Front base | area | density | addition | variation |
| Sphere (D) | curve (D) | strength | (%) | (D) | (D) |
| 0 | 6 | High | 40 | 4 | 2 |
| 0 | 6 | Medium | 30 | 3 | 1 |
| 0 | 6 | Low | 20 | 2 | 0 |
| −2 | 4 | High | 40 | 4 | 2 |
| −2 | 4 | Medium | 30 | 3 | 1 |
| −2 | 4 | Low | 20 | 2 | 0 |
| −4 | 3 | High | 40 | 4 | 2 |
| −4 | 3 | Medium | 30 | 3 | 1 |
| −4 | 3 | Low | 20 | 2 | 0 |
| −6 | 2 | High | 60 | 5 | 2.5 |
| −6 | 2 | Medium | 30 | 3.5 | 1.25 |
| −6 | 2 | Low | 20 | 2 | 0 |

If the considered vision impairment is myopia, in a fourth non-limiting example, there are no optical areas on the front surface of the semi-finished lens, but there are optical areas only on the back surface of the semi-finished lens. For instance, there may be only a varying continuous base curve for different prescriptions.

Thus, at the end of step 12, the semi-finished lens has been selected, so that the starting geometry of the lens is known and an optimization process will now be carried out, as described below.

The base geometry of the surface of the semi-finished lens comprising the optical areas, i.e. its front and/or back surface, may be a smooth portion outside the optical areas. It may be either aspheric, or even freeform (e.g. Zernike surface), so as to improve optical performance away from the central gaze direction. By way of non-limiting example, the free parameters for the optical areas may be the power, the area size and the density of optical areas.

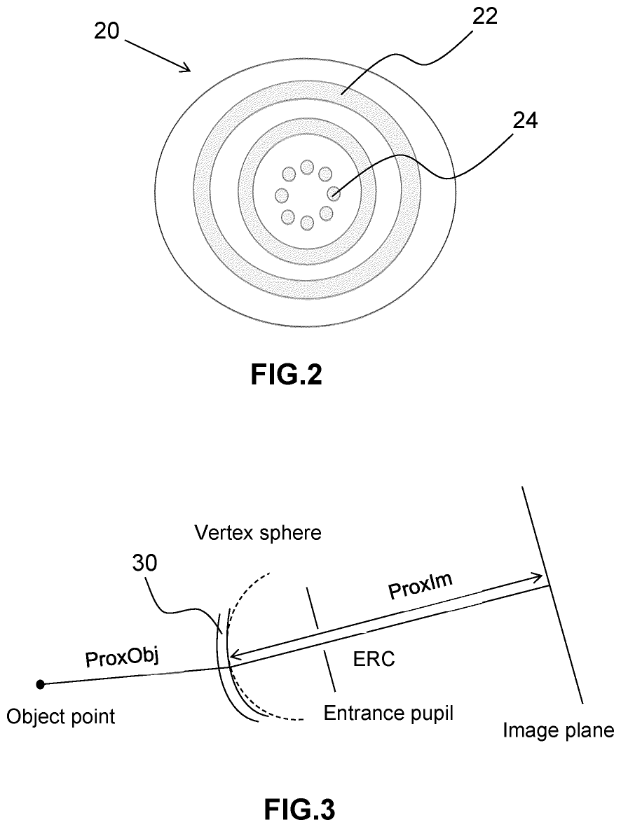

FIG. 2 shows a semi-finished lens 20 having a non-limiting example of patterns of optical areas that comprise rings 22 and circles 24. Any other predefined shape may be envisioned.

As a variant, the base geometry of the surface of the semi-finished lens comprising the optical areas may be entirely freeform. Thus, there may be no predefined patterns of optical areas. In such an embodiment, the optical areas will appear at the optimization stage.

Returning to FIG. 1, during a following step 14 of the method, one or more optical targets taking account of the plurality of wearer parameters are defined, for the front surface and/or the back surface of the ophthalmic lens that is to be determined.

Then, during a step 16, a cost function relating to the optical target(s) is minimized, so as to determine an optimized front and/or back surface of the semi-finished lens as the front and/or back surface of the final ophthalmic lens.

In a first embodiment, the optical targets comprise at least one target relating to a prescription area on the front surface and/or the back surface that corresponds to the wearer's prescription and at least one target relating to the one or more optical areas.

In that first embodiment, the optical targets are wearer power and resulting astigmatism targets for all gaze directions. Optical areas will purposely have power error and/or astigmatism.

Let us assume that the considered vision impairment is myopia and let us define G_{RX} and G_{MC} the sets of gaze directions, respectively for the prescription area and for myopia control i.e. the optical areas.

The complete cost functions may be decomposed into two parts.

For the prescription area part, the part CF_{RX}(X) of the cost function, where X is the set of the degrees of freedom of the surface of the semi-finished lens being optimized, may be defined as follows:

$${CF}_{RX} ( X ) = {\sum }_{{g}_{rx} ∈ {G}_{RX}} {w}_{rx} [ {( WearerPower ( X , {g}_{rx} ) - {WearerPower}_{{g}_{rx}}^{T} )}^{2} + {ResultingAstigmatism ( X , {g}_{rx} )}^{2} ]$$

where gᵣₓ is a gaze direction, wᵣₓ is a positive weighting coefficient lower than or equal to 1, WearerPower is the lens power, T refers to the optical target and ResultingAstigmatism is the lens resulting (or unwanted) astigmatism, in which the cylinder and axis of the prescription are integrated.

Thus, the part CF_{RX}(X) of the cost function is calculated for a first set of gaze directions G_{RX}.

The prescription area will generally target a power error and an astigmatism equal to zero. This means that usually, WearerPower^{T}_{grx} is the mean spherical power of the prescription.

For the myopia control part i.e. the optical area part, the part CF_{MC}(X) of the cost function may be defined as follows:

$${CF}_{MC} ( X ) = {\sum }_{{g}_{mc} ∈ {G}_{MC}} {w}_{mc} [ \text{} ( PowerError ( X , {g}_{mc} ) - {{PowerError}_{{g}_{mc}}^{T} )}^{2} + \text{} ( {Astigmatism ( X , {g}_{mc} )}^{2} - {{Astigmatism}_{{g}_{mc}}^{T} )}^{2} \text{} + {( AstigmatismAxis {( X , {g}_{mc} )}^{2} - {AstigmatismAxis}_{{g}_{mc}}^{T} )}^{2} ]$$

where g_{mc} is a gaze direction, w_{mc} is a positive weighting coefficient lower than or equal to 1 such that wᵣₓ+w_{rc}=1, PowerError is the power error, T refers to the optical target, Astigmatism is the astigmatism and AstigmatismAxis is the axis of the astigmatism.

Thus, the part CF_{MC}(X) of the cost function is calculated for a second set of gaze directions G_{MC}.

WearerPower^{T}_{grx} will purposely be different from the prescription in order to create a defocus or unfocused signal with respect to the retina.

It is to be noted that the power/astigmatism calculation is performed in wearer mode, meaning that the incidence angle of the rays as well as the wearing parameters (eye-lens distance, pantoscopic/galb angles) are accounted for. Optical propagation software such as ray tracing or a refinement method using diffractive calculation may be used to calculate the optical propagation through the lens front surface, the lens substrate, the lens back surface, until reaching the defined gaze direction.

The optimization process then consists in minimizing a cost function that is the sum of the first cost function CF_{RX}(X) including the first weighting coefficient wᵣₓ and the second cost function CF_{MC}(X) including the second weighting coefficient w_{mc}:

$${min}_{X} CF ( X ) = {min}_{X} [ {CF}_{RX} ( X ) + {CF}_{MC} ( X ) ]$$

As a variant, the same method may be used for gaze directions relating to the prescription area and a different definition may be used for the optical area. For the optical area, PowerError_{g}_{_{mc}}^{T} may be defined as being the power provided for the peripheral gaze direction g_{mc}. In other words, the wearer is looking at the lens optical center and PowerError_{g}_{_{mc}}^{T} is calculated as being the refractive error to be provided for peripheral rays having a g_{mc} inclination with respect to central vision.

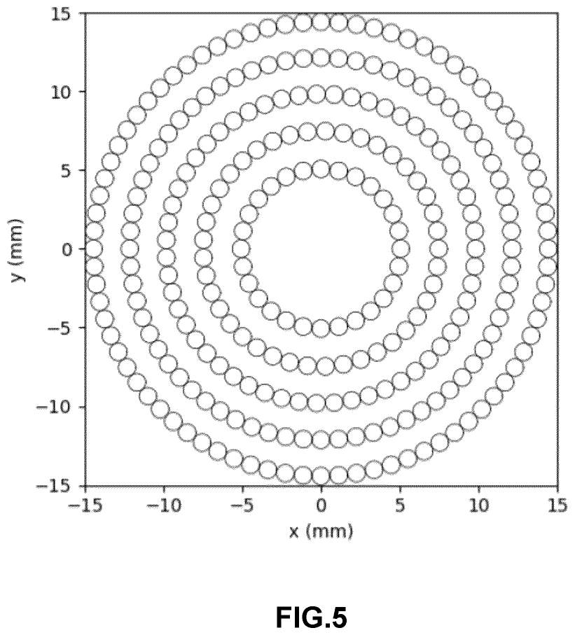

FIGS. 5 to 8 show a non-limiting example of the application of the method according to the present disclosure to a semi-finished lens selected to correspond to a sphere prescription of −4 diopter, where the vision impairment is myopia and the optical areas are therefore myopia control areas.

The graph of FIG. 5 shows the pattern of the myopia control areas located on the back surface of the lens.

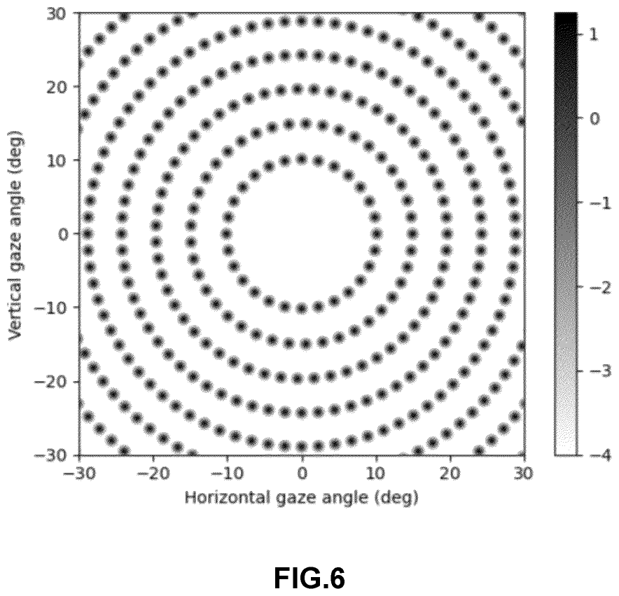

The graph of FIG. 6 shows the wearer power target in diopter for the myopia control areas. It is assumed that astigmatism targets are null for all gaze directions.

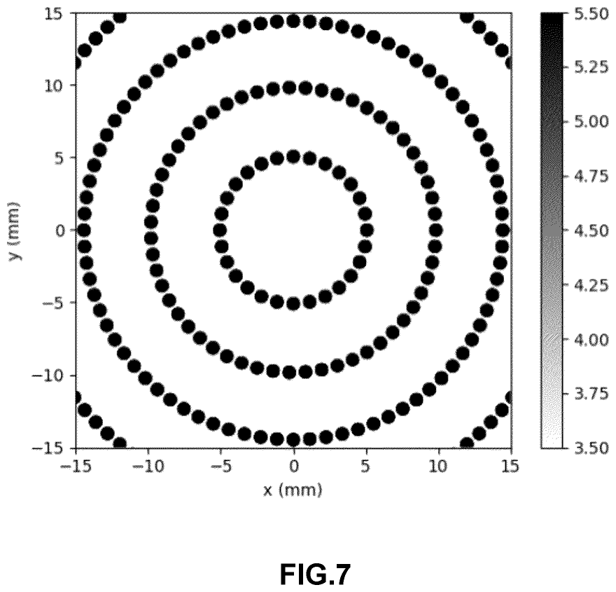

The graph of FIG. 7 shows the distribution of the mean surfacic power of the front surface of the semi-finished lens. The refraction index difference dn between the air and the material of the substrate of the front surface of the lens is 0.591.

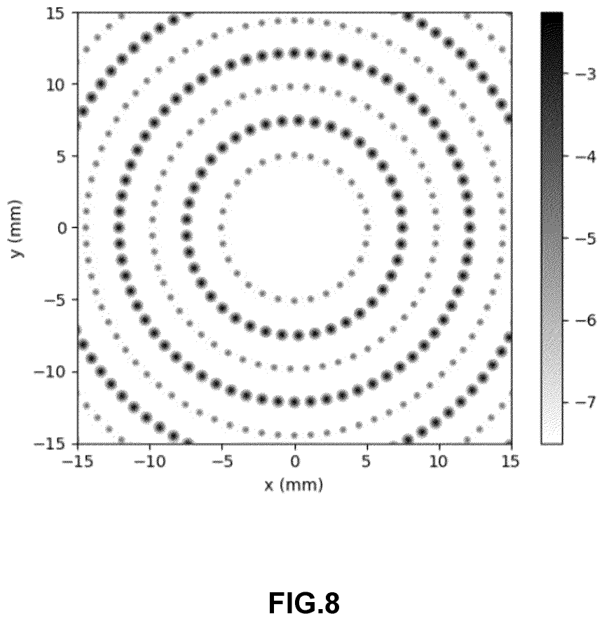

The graph of FIG. 8 shows the distribution of the mean surfacic power of the resulting optimized back surface obtained by the method according to the present disclosure. The refraction index difference dn between the air and the material of the substrate of the back surface of the lens is 0.591.

As shown in FIG. 1, a final optional step 18 of the method is to perform digital surfacing of the front surface of the semi-finished lens according to the optimized front surface obtained at the end of step 16 and/or digital surfacing of the back surface of the semi-finished lens according to the optimized back surface obtained at the end of step 16.

If the ophthalmic lens undergoes a coating process that is known to modify the properties of surfaces with optical areas, then the optimization and digital surfacing steps 16, 18 may be leveraged to compensate for such effect. Namely, if the coating process is known to modify an optical surface through a transfer function, then the optimization step will become min_{X}CF(f(X)).

In a second embodiment, the optical targets relate to a modulation transfer function MTF, which may be an advantageous alternative to power error and resulting astigmatism. The MTF gives the modulation rate, i.e. the oscillation between white and black, representing the contrast between the image and the object, as a function of the measured spatial frequency of the discriminated objects.

In that second embodiment, the cost function is calculated for a set D of values of the diameter of the pupil of the eye and for a third set G of gaze directions. The third set of gaze directions is defined so as to reasonable constrain the optimization and ensure that the obtained front and/or back surfaces yield an ophthalmic lens the overall design of which is very close to the target.

By way of non-limiting example, D=[4 mm, 6 mm] and G is a uniform sampling of a 60° cone centered on the eye rotation center. Since a single calculation will use an extended area of the lens, there is no need to choose a very fine gaze sampling. A sampling step around 5° is sufficient. In addition, a single MTF calculation will capture both the prescription areas and the optical areas of the lens.

In that second embodiment, the cost function CF(X) may be defined as follows:

$$CF ( X ) = {\sum }_{d ∈ D} {\sum }_{g ∈ G} {{w}_{g} ( MTF ( X , g , d ) - {MTF}_{g , d}^{T} )}_{[ {f}_{min} , {f}_{max} ]}^{2}$$

where d is a pupil diameter, g is a gaze direction, w_{g} is a positive weighting coefficient lower than or equal to 1, T refers to the optical target and [fₘᵢₙ, fₘₐₓ] is a spatial frequency range that is relevant to both visual acuity and myopia control. By way of non-limiting example, fₘᵢₙ=0 cycle per degree and fₘₐₓ=30 cycles per degree.

FIG. 3 illustrates the configuration used in the calculations.

For a specific gaze direction through the lens 30, a ray is propagated to the object space from the eye rotation center (ERC on the drawing). An object point is then calculated using an ergorama, which associates gaze directions to proximities. Let us denote ProxObj the object proximity of interest.

Assuming that the target wearer power is P, the image plane should be positioned at a proximity ProxIm=P−ProxObj from the vertex sphere, calculated along the ERC-pupil axis. The vertex sphere is centered on the ERC and intersects the back surface of the lens 30. The radius of the vertex sphere is the distance between the ERC and the lens 30.

Once the object point as well as the image plane are well defined, the point spread function (PSF) and the MTF are computed as they are usually computed for any optical system. Namely, a beam of rays is propagated from the object point to the eye entrance pupil (which is the same as he lens exit pupil), so as to perform a regular sampling of the pupil. The optical path lengths may be stored during this process. The optical path lengths are then used to compute the pupil function. A diffraction integral is then applied to the pupil function in order to obtain the PSF. Last, the MTF is computed from the PSF using a Fourier transform.

The above calculation is in “wearer mode”, meaning that the eye-lens distance as well as the pantoscopic and wrap angles and the fitting cross position are accounted for.

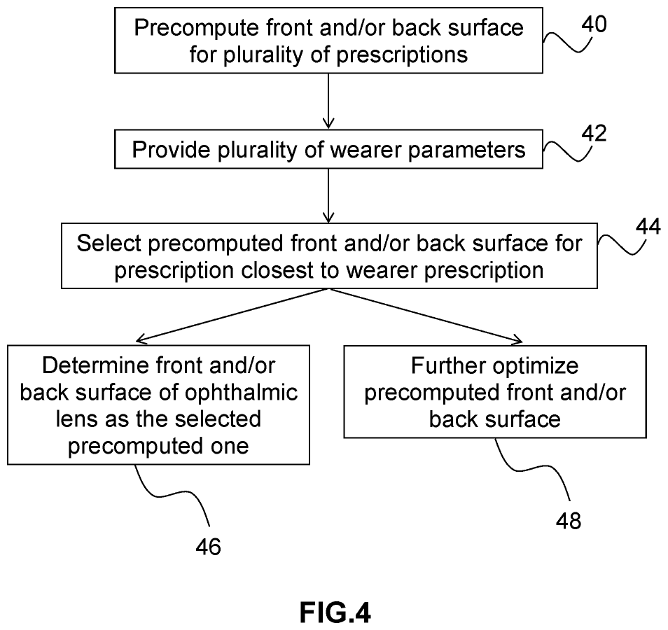

A variant of the method for determining an ophthalmic lens adapted to slow down the progression of a vision impairment of an eye of a specific wearer making it possible to reduce the calculation time by building a database of precomputed front and/or back surfaces is described below with reference to FIG. 4.

During a first step 40, for each one of a plurality of prescriptions, the front and/or the back surface of the ophthalmic lens is precomputed, by applying the above-described method, namely, by:
selecting, among a plurality of semi-finished lenses, a semi-finished lens that best corresponds to the considered prescription;
defining one or more optical targets for the considered front and/or back surface, the optical target(s) taking account of a plurality of parameters of a theoretical wearer, comprising at least the considered prescription and an indication about the need for slowing down the progression of the vision impairment of the eye of the theoretical wearer;
minimizing a cost function relating to the optical target(s), so as to determine an optimized front and/or back surface of the semi-finished lens as the front and/or back surface of the ophthalmic lens for the considered prescription.

Thus, a plurality of precomputed front and/or back surfaces is obtained.

The plurality of prescriptions may be defined by a sampling of the prescription space, as follows:

(S,C,A)ᵢ∈[Sₘᵢₙ:Sₘₐₓ:ΔS]×[Cₘᵢₙ:Cₘₐₓ:ΔC]×[Aₘᵢₙ:Aₘₐₓ:ΔA]

where S is the mean sphere, C is the cylinder and A is the axis, min indicates the minimum value, max indicates the maximum value and Δ indicates the step between two successive values of the interval between the minimum and the maximum values.

By way of non-limiting example, if the considered vision impairment is myopia, the following values may be chosen:
Sₘᵢₙ=−6 D, Sₘₐₓ=0 D, ΔS=0.5 D
Cₘᵢₙ=0 D, Cₘₐₓ=2 D, ΔC=0.5 D
Aₘᵢₙ=0°, Aₘₐₓ=150°, ΔA=30°

This would yield 13×5×6=390 combinations, i.e. 390 prescriptions in the plurality of prescriptions.

During a following step 42, a plurality of parameters of the specific wearer is provided. It comprises at least a wearer prescription of the specific wearer and an indication about the need for slowing down the progression of a vision impairment of the eye of the specific wearer.

During a following step 44, a precomputed front and/or back surface is selected among the plurality of precomputed front and/or back surfaces, the corresponding prescription of the plurality of prescriptions being the closest to the wearer prescription of the specific wearer. As a variant, the precomputed front and/or back surface of the ophthalmic lens for the specific wearer may be interpolated from the surfaces of multiple nearby prescriptions.

Then, there are two options. Either, at a step 46, the front and/or back surface of the ophthalmic lens for the specific wearer is determined as the selected precomputed front and/or back surface obtained at step 44, or, at a step 48, the selected precomputed front and/or back surface obtained at step 44 is further optimized, by:
defining one or more optical targets for the front and/or back surface of the ophthalmic lens for the specific wearer, the optical target(s) taking account of the plurality of parameters of the specific wearer provided at step 42;
minimizing a cost function relating to the optical target(s), so as to determine an optimized precomputed front and/or back surface as the front and/or back surface of the ophthalmic lens for the specific wearer.

An ophthalmic lens according to the present disclosure is adapted to slow down the progression of a vision impairment of an eye of a wearer. It has a front surface and a back surface and at least one optical area on the front surface and/or on the back surface not focusing an image on the retina of the eye. The front surface and/or the back surface of the lens are determined by any of the above-described methods.

In a particular embodiment, the method according to the disclosure is computer-implemented. Namely, a computer program product comprises one or more sequences of instructions that are accessible to a processor and that, when executed by the processor, cause the processor to carry out steps of the method as described above for determining an ophthalmic lens adapted to slow down the progression of a vision impairment of an eye of a wearer.

The sequence(s) of instructions may be stored in one or several non-transitory computer-readable storage medium/media, including a predetermined location in a cloud.

The present disclosure makes it possible not only to significantly improve the slowing down of the progression of a vision impairment with respect to prior art methods, but also to best preserve visual acuity for all gaze directions, including when looking through the parts of the ophthalmic lens comprising the above-mentioned optical areas not focusing an image on the retina.

Although representative systems and methods have been described in detail herein, those skilled in the art will recognize that various substitutions and modifications may be made without departing from the scope of what is described and defined by the appended claims.

1. A method for determining an ophthalmic lens adapted to slow down progression of a vision impairment of an eye of a wearer, said ophthalmic lens having a front surface and a back surface and at least one optical area not focusing an image on a retina of the eye, said method comprising:
providing a plurality of wearer parameters, comprising at least a prescription and an indication about a need for slowing down the progression of the vision impairment of the eye of the wearer;
selecting, among a plurality of semi-finished lenses, a semi-finished lens that best corresponds to at least said prescription;
defining at least one optical target for at least one of said front and back surfaces, said at least one optical target taking account of said plurality of wearer parameters; and
minimizing a cost function relating to said at least one optical target, so as to determine at least one of an optimized front surface and an optimized back surface of said semi-finished lens as at least one of said front and back surfaces of said ophthalmic lens.

2. The method according to claim 1, further comprising digital surfacing at least one of said front surface according to said optimized front surface and said back surface according to said optimized back surface.

3. The method according to claim 1, wherein said at least one optical area comprises at least one micro-structure.

4. The method according to claim 1, wherein said vision impairment is myopia.

5. The method according to claim 4, wherein said plurality of wearer parameters further comprises a myopia progression rate.

6. The method according to claim 1, wherein said plurality of wearer parameters further comprises fitting parameters.

7. The method according to claim 1, wherein:
said at least one optical target comprises at least one target relating to a prescription area on at least one of said front and back surfaces that corresponds to said prescription and at least one target relating to said at least one optical area; and
said cost function comprises a first cost function relating to said prescription and calculated for a first set of gaze directions and a second cost function relating to said at least one optical area and calculated for a second set of gaze directions.

8. The method according to claim 7, wherein said cost function is a sum of said first cost function weighted by a first weighting coefficient and said second cost function weighted by a second weighting coefficient.

9. The method according to claim 1, wherein said at least one optical target relates to a modulation transfer function and said cost function is calculated for a set of values of a diameter of a pupil of said eye and for a third set of gaze directions.

10. The method according to claim 1, further comprising:
for each one of a plurality of prescriptions, precomputing at least one of said front and back surfaces by applying said selecting, defining and minimizing steps to each one of said plurality of prescriptions:
selecting, among a plurality of semi-finished lenses, a semi-finished lens that best corresponds to at least said one of said plurality of prescriptions, so as to obtain a plurality of precomputed front and/or back surfaces;
providing a plurality of parameters of said wearer, comprising at least a wearer prescription of said wearer and an indication about the need for slowing down the progression of a vision impairment of the eye of the wearer;
selecting, among said plurality of precomputed front and/or back surfaces, at least one of a precomputed front surface and a precomputed back surface for a prescription of said plurality of prescriptions that is closest to said wearer prescription of said wearer; and
either determining at least one of the front and back surfaces of said ophthalmic lens for said wearer as the at least one of said precomputed front surface and said precomputed back surface obtained at said selecting said precomputed surfaces,
or further optimizing the at least one of said precomputed front and back surfaces obtained at said selecting said precomputed surfaces, by:
defining at least one optical target for at least one of the front and back surfaces of said ophthalmic lens for said wearer, said at least one optical target taking account of said plurality of parameters of said wearer; and
minimizing a cost function relating to said at least one optical target, so as to determine at least one of an optimized precomputed front surface and an optimized precomputed back surface as at least one of said front and back surfaces of said ophthalmic lens for said wearer.

11. A device comprising:
a processor configured to:
obtain a plurality of wearer parameters comprising at least a prescription and an indication about a need for slowing down progression of a vision impairment of an eye of a wearer,
select, among a plurality of semi-finished lenses, a semi-finished lens that best corresponds to at least said prescription,
define at least one optical target for at least one of a front surface and a back surface of an ophthalmic lens adapted to slow down the progression of the vision impairment of the eye of the wearer, said ophthalmic lens also having at least one optical area not focusing an image on a retina of the eye, said at least one optical target taking account of said plurality of wearer parameters, and
minimize a cost function relating to said at least one optical target, so as to determine at least one of an optimized front surface and an optimized back surface of said semi-finished lens as said at least one of said front and back surfaces of said ophthalmic lens.

12. A non-transitory information storage medium, wherein it stores one or more sequences of instructions that are accessible to a processor and that, when executed by said processor, cause said processor to:
obtain a plurality of wearer parameters comprising at least a prescription and an indication about a need for slowing down progression of a vision impairment of an eye of a wearer;
select, among a plurality of semi-finished lenses, a semi-finished lens that best corresponds to at least said prescription;
define at least one optical target for at least one of a front surface and a back surface of an ophthalmic lens adapted to slow down the progression of the vision impairment of the eye of the wearer, said ophthalmic lens also having at least one optical area not focusing an image on a retina of the eye, said at least one optical target taking account of said plurality of wearer parameters; and
minimize a cost function relating to said at least one optical target, so as to determine at least one of an optimized front surface and an optimized back surface of said semi-finished lens as said at least one of said front and back surfaces of said ophthalmic lens.

13. The method according to claim 2, wherein said at least one optical area comprises at least one micro-structure.

14. The method according to claim 13, wherein said vision impairment is myopia.

15. The method according to claim 14, wherein said plurality of wearer parameters further comprises a myopia progression rate.

16. The method according to claim 15, wherein said plurality of wearer parameters further comprises fitting parameters.

17. The method according to claim 16, wherein:
said at least one optical target comprises at least one target relating to a prescription area on at least one of said front and back surfaces that corresponds to said prescription and at least one target relating to said at least one optical area; and
said cost function comprises a first cost function relating to said prescription and calculated for a first set of gaze directions and a second cost function relating to said at least one optical area and calculated for a second set of gaze directions.

18. The method according to claim 17, wherein said cost function is a sum of said first cost function weighted by a first weighting coefficient and said second cost function weighted by a second weighting coefficient.

19. The method according to claim 18, wherein said at least one optical target relates to a modulation transfer function and said cost function is calculated for a set of values of a diameter of a pupil of said eye and for a third set of gaze directions.

20. The method according to claim 19, further comprising:
for each one of a plurality of prescriptions, precomputing at least one of said front and back surfaces by applying said selecting, defining and minimizing steps to each one of said plurality of prescriptions:
selecting, among a plurality of semi-finished lenses, a semi-finished lens that best corresponds to at least said one of said plurality of prescriptions, so as to obtain a plurality of precomputed front and/or back surfaces;
providing a plurality of parameters of said wearer, comprising at least a wearer prescription of said wearer and an indication about the need for slowing down the progression of a vision impairment of the eye of the wearer;
selecting, among said plurality of precomputed front and/or back surfaces, at least one of a precomputed front surface and a precomputed back surface for a prescription of said plurality of prescriptions that is closest to said wearer prescription of said wearer; and
either determining at least one of the front and back surfaces of said ophthalmic lens for said wearer as the at least one of said precomputed front surface and said precomputed back surface obtained at said selecting said precomputed surfaces,
or further optimizing the at least one of said precomputed front and back surfaces obtained at said selecting said precomputed surfaces, by:
defining at least one optical target for at least one of the front and back surfaces of said ophthalmic lens for said wearer, said at least one optical target taking account of said plurality of parameters of said wearer; and
minimizing a cost function relating to said at least one optical target, so as to determine at least one of an optimized precomputed front surface and an optimized precomputed back surface as at least one of said front and back surfaces of said ophthalmic lens for said wearer.
